(19) United States
(12) Patent Application Publication
(10) Pub. No.: US 2025/0239780 A1
(43) Pub. Date: Jul. 24, 2025

(54) ANTENNA DEVICE AND ELECTRONIC APPARATUS

(71) Applicant: Murata Manufacturing Co., Ltd., Nagaokakyo-shi (JP)

(72) Inventors: Takafumi NASU, Nagaokakyo-shi (JP); Shigeyuki FUJIEDA, Nagaokakyo-shi (JP)

(21) Appl. No.: 19/175,238

(22) Filed: Apr. 10, 2025

Related U.S. Application Data
(63) Continuation of application No. PCT/JP2023/043793, filed on Dec. 7, 2023.

(30) Foreign Application Priority Data
Dec. 9, 2022 (JP) 2022-196958
May 30, 2023 (JP) 2023-088797

(51) Int. Cl. H01Q 13/10; H01Q 7/00

(52) U.S. Cl. CPC H01Q 13/106; H01Q 7/00

(57) ABSTRACT

An antenna device includes a conductor with a planar shape and a slot, first and second excitation electrodes at positions corresponding to the slot, and first and second coils. A first end of the first coil is electrically connected to the first excitation electrode, and a second end of the first coil is connected to a feed circuit. One end of the second coil is electrically connected to the second excitation electrode. The first and second coils are positioned to be magnetically coupled with each other.

### CROSS REFERENCE TO RELATED APPLICATIONS

This application claims the benefit of priority to Japanese Patent Application No. 2022-196958 filed on Dec. 9, 2022 and Japanese Patent Application No. 2023-088797 filed on May 30, 2023, and is a Continuation Application of PCT Application No. PCT/JP2023/043793 filed on Dec. 7, 2023. The entire contents of each application are hereby incorporated herein by reference.

### BACKGROUND OF THE INVENTION

### 1. Field of the invention

The present disclosure relates to antenna devices and electronic apparatuses.

### 2. Description of the Related Art

These days, an antenna is not provided outside an electronic apparatus, but is contained inside from a design perspective. Additionally, in case of an accident, for example, when an electronic apparatus including a built-in antenna is dropped, the antenna can be protected from damage. As a built-in antenna of an electronic apparatus, a slot antenna is disclosed in Japanese Unexamined Patent Application Publication No. H9-74312.

### SUMMARY OF THE INVENTION

The resonant frequency of a slot antenna is determined by the length of a slot. Because of this characteristic, the slot antenna is not suitable as a built-in antenna of an electronic apparatus that is desired to operate in multiple frequency bands.

Accordingly, example embodiments of the present invention provide antenna devices and electronic apparatuses that each can widen a frequency band to be used in the electronic apparatuses.

An antenna device according to an example embodiment of the present disclosure includes a conductor with a planar shape and a slot, first and second excitation electrodes at positions corresponding to the slot, a first coil including a first end electrically connected to the first excitation electrode and a second end connected to a feed circuit, and a second coil including a first end electrically connected to the second excitation electrode, wherein the first coil and the second coil are positioned to be magnetically coupled with each other.

An electronic apparatus according to an example embodiment of the present disclosure includes the above-described antenna device, the feed circuit to feed power to the first excitation electrode, and a housing that houses the antenna device and the feed circuit.

According to example embodiments of the present disclosure, as a result of respectively connecting the first and second excitation electrodes, which are at positions corresponding to the slot, to the first and second coils magnetically coupled with each other, an additional resonance point can be provided to widen the frequency band to be used.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic view of an electronic apparatus including an antenna device of a first example embodiment of the present invention.

FIG. 2 is an enlarged partial view of the antenna device of the first example embodiment of the present invention.

FIG. 3 is a schematic sectional view of the antenna device of the first example embodiment of the present invention.

FIG. 4 is an equivalent circuit diagram of the antenna device of the first example embodiment of the present invention.

FIG. 5 is a graph illustrating the frequency characteristics of the antenna device of the first example embodiment of the present invention regarding the reflection coefficient.

FIG. 6 is a Smith chart of the antenna device of the first example embodiment of the present invention.

FIG. 7 is a schematic view of an antenna device of a comparative example.

FIG. 8 is a graph illustrating the frequency characteristics of the antenna device of the comparative example shown in FIG. 7 regarding the reflection coefficient.

FIG. 9 is a Smith chart of the antenna device of the comparative example shown in FIG. 7.

FIG. 10 is a perspective view of an antenna coupler of the first example embodiment of the present invention.

FIG. 11 is a plan view of the antenna coupler of the first example embodiment of the present invention.

FIGS. 12A to 12H are first exploded plan views illustrating the configuration of the antenna coupler of the first example embodiment of the present invention.

FIGS. 13I to 13O are second exploded plan views illustrating the configuration of the antenna coupler of the first example embodiment of the present invention.

FIG. 14 is a schematic view of an antenna device of another comparative example.

FIG. 15 is a graph illustrating the frequency characteristics of the antenna device of the comparative example shown in FIG. 14 regarding the reflection coefficient.

FIG. 16 is a Smith chart of the antenna device of the comparative example shown in FIG. 14.

FIG. 17 is a schematic view of an antenna device of another comparative example.

FIG. 18 is a graph illustrating the frequency characteristics of the antenna device of the comparative example shown in FIG. 17 regarding the reflection coefficient.

FIG. 19 is a Smith chart of the antenna device of the comparative example shown in FIG. 17.

FIG. 20 is a graph illustrating the frequency characteristics of an antenna device regarding the reflection coefficient after the capacitance of a capacitor is changed.

FIG. 21 is a Smith chart of the antenna device in which the capacitance of the capacitor is changed.

FIG. 22 is a sectional view of an antenna device according to a modified example.

FIG. 23 is a schematic view of an electronic apparatus including an antenna device of a second example embodiment of the present invention.

FIG. 24 is a graph illustrating the frequency characteristics of the antenna device of the second example embodiment of the present invention regarding the reflection coefficient.

FIG. 25 is a graph illustrating the antenna efficiency of the antenna device of the second example embodiment of the present invention.

FIG. 26 is a schematic view of an electronic apparatus including an antenna device of a first modified example of the second example embodiment of the present invention.

FIG. 27 is a schematic view of an electronic apparatus including an antenna device of a second modified example of the second example embodiment of the present invention.

FIG. 28 is a schematic view of an electronic apparatus including an antenna device of a third modified example of the second example embodiment of the present invention.

### DETAILED DESCRIPTION OF THE EXAMPLE EMBODIMENTS

Antenna devices and electronic apparatuses according to example embodiments will be described below in detail with reference to the drawings. The same or corresponding elements in the drawings are designated by like reference numeral and an explanation thereof will not be repeated.

### First Example Embodiment

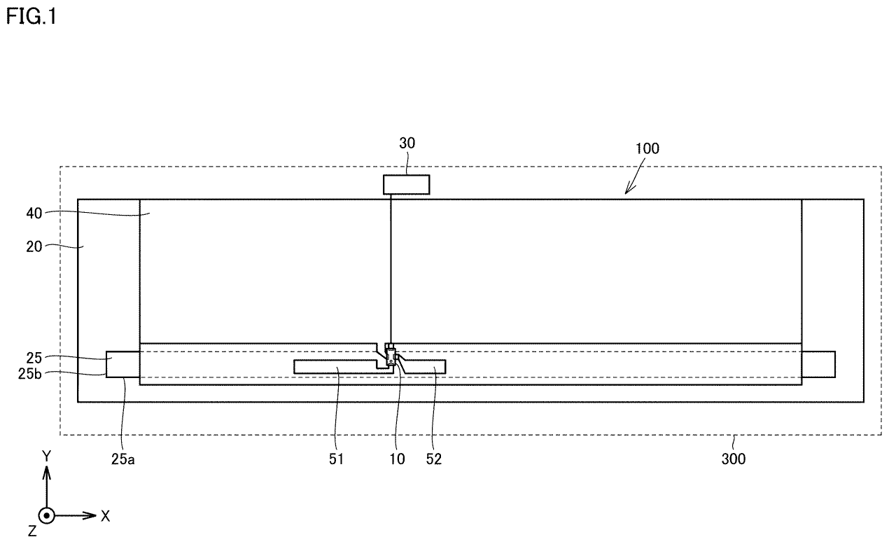

An electronic apparatus including an antenna device will first be explained below. FIG. 1 is a schematic view of an electronic apparatus including an antenna device 100 of a first example embodiment. As illustrated in FIG. 1, the electronic apparatus includes the antenna device 100, a feed circuit 30 to feed power to an excitation electrode 51 (first excitation electrode), and a housing 300 that houses the antenna device 100 and the feed circuit 30. The electronic apparatus is a laptop personal computer, a mobile phone, a smartphone, or a tablet, for example, that includes the antenna device 100. The antenna device 100 can perform communication using bands including the 2.4 GHz band and the 5 to 7 GHz band, for example.

### Configuration of Antenna Device

In the antenna device 100, a slot 25 elongated in the X direction is provided in a planar conductor 20, and excitation electrodes 51 and 52 (also be simply called an excitation conductor, a feed line, or a microstrip line) are provided at positions corresponding to the slot 25. “The excitation electrodes 51 and 52 are provided at positions corresponding to the slot 25” refers to a state in which the excitation electrodes 51 and 52 overlap the slot 25 in a plan view of the slot 25. That is, the antenna device 100 is a slot antenna in which the excitation electrodes 51 and 52 operate as a capacitor feed element with respect to the slot 25. In the antenna device 100, which is a slot antenna, the length of a long side 25a of the slot 25 (slot length) is roughly half (λ/2) of the resonance wavelength, for example. When the antenna device 100 is used in the approximately 2 GHz to 3 GHz band, the length of the long side 25a of the slot 25 is thus about 40 mm to about 70 mm, for example. The length of a short side 25b of the slot 25 (slot width) is, for example, about 1 to 5 mm, which is shorter than the long side 25a. That is, the slot 25 has a rectangular or substantially rectangular shape in which the short side 25b (second side) is shorter than the long side 25a (first side). The conductor 20 is, for example, a metal plate, such as a copper foil, a copper plate, or an aluminum plate.

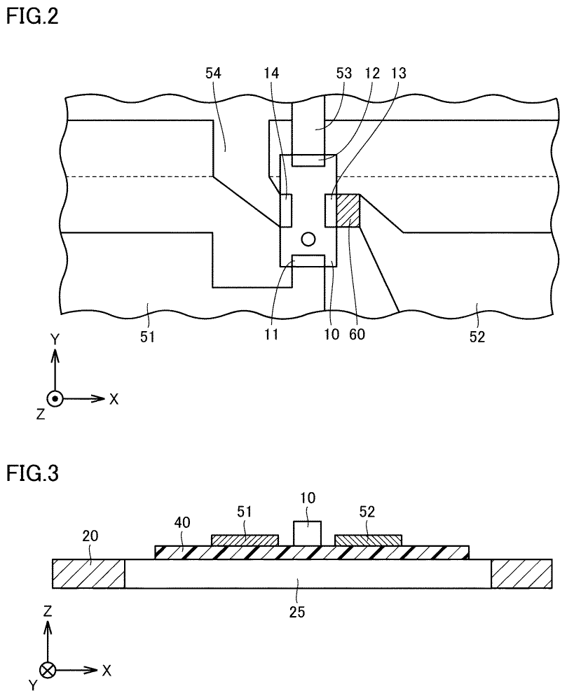

The configuration of the antenna device 100 will be explained below in greater details. FIG. 2 is an enlarged partial view of the antenna device 100 of the first example embodiment. FIG. 3 is a schematic sectional view of the antenna device 100 of the first example embodiment. As shown in FIG. 1, the excitation electrodes 51 and 52 are located at positions at which they overlap the slot 25 in a plan view of the slot 25. As shown in FIG. 3, the excitation electrodes 51 and 52 are provided on a substrate on the conductor 20 so that they do not directly overlap the slot 25 in the Z direction. It is sufficient, however, if the excitation electrodes 51 and 52 are provided at positions corresponding to the slot 25. The excitation electrodes 51 and 52 may be provided at positions at which they overlap the slot 25 in a plan view of the slot 25 and also in the Z direction. The excitation electrodes 51 and 52 have a strip-like shape extending along the long side 25a of the slot 25.

The excitation electrodes 51 and 52 are electrically connected to an antenna coupler 10 mounted on the substrate 40. The substrate 40 is a PWB (Printed Wired Board), for example, and the antenna coupler 10 is connected to the substrate 40 by using a solder or a conductive paste. As illustrated in FIG. 1, the excitation electrode 51 is connected to the feed circuit 30 via the antenna coupler 10, and power is fed from the feed circuit 30 to the excitation electrode 51. In contrast, the excitation electrode 52 (second excitation electrode) is connected to the substrate 40 via the antenna coupler 10 and is connected to a GND (is grounded). That is, a slot antenna including the slot 25 and the excitation electrode 51 defines and functions as a feed antenna, while a slot antenna including the slot 25 and the excitation electrode 52 defines and functions as a parasitic antenna.

The excitation electrode 51 extends from the antenna coupler 10 to the left side (first direction) in FIGS. 1 and 2, while the excitation electrode 52 extends from the antenna coupler 10 to the right side (second direction) in FIGS. 1 and 2. That is, the extending direction of the excitation electrode 51 and that of the excitation electrode 52 are opposite directions along the long side 25a of the slot 25. Alternatively, the extending direction of the excitation electrode 51 and that of the excitation electrode 52 may be the same direction.

The antenna coupler 10 includes a coil L1 (first coil) and a coil L2 (second coil), which are magnetically coupled with each other. This will be discussed later. As shown in FIG. 2, the excitation electrode 51 is connected to a first outer electrode 11 of the antenna coupler 10 so as to be electrically connected to the coil L1. The feed circuit 30 is connected to a second outer electrode 12 of the antenna coupler 10 via a line 53 so as to be electrically connected to the coil L1. The excitation electrode 52 is connected to a third outer electrode 13 of the antenna coupler 10 so as to be electrically connected to the coil L2. The excitation electrode 52 is connected to the third outer electrode 13 via a capacitor 60 so as to adjust the impedance, which will be discussed later. A fourth outer electrode 14 of the antenna coupler 10 is connected to the substrate 40 via a line 54 so as to connect the coil L2 to a GND.

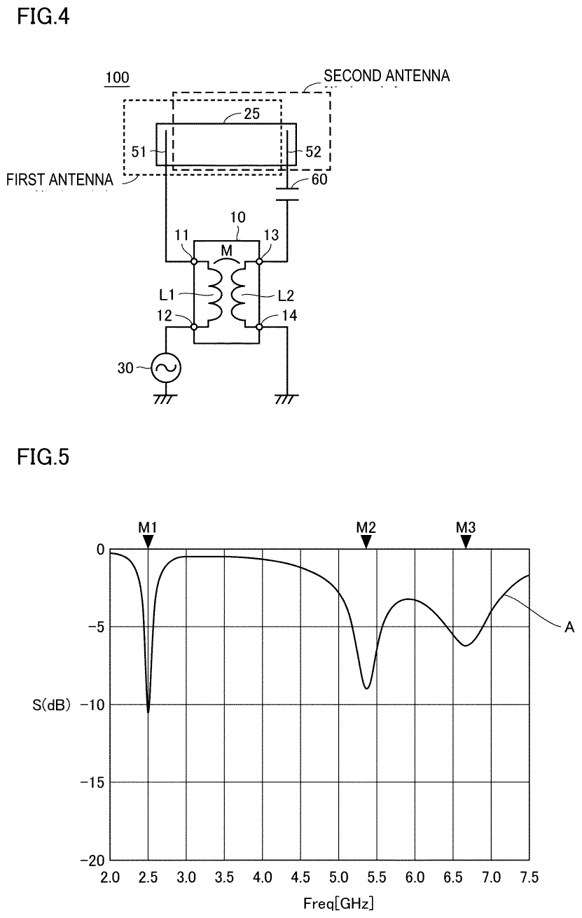

In the antenna device 100, resonance produced by the excitation electrode 51 and that by the excitation electrode 52 in the slot antenna are coupled with each other by using the antenna coupler 10. FIG. 4 is an equivalent circuit diagram of the antenna device 100 of the first example embodiment. In the antenna device 100, the excitation electrode 51 of the slot antenna, which is connected to the feed circuit 30, and the excitation electrode 52 of the slot antenna, which does not receive power from the feed circuit 30, are coupled with each other by using the antenna coupler 10.

In the equivalent circuit diagram of the antenna device 100 in FIG. 4, the excitation electrode 51 and the slot 25 form a slot antenna (first antenna). The excitation electrode 51 is electrically connected to the first outer electrode 11 of the antenna coupler 10, while the feed circuit 30 is electrically connected to the second outer electrode 12 of the antenna coupler 10. That is, the coil L1 of the antenna coupler 10 is connected in series with the excitation electrode 51 and the feed circuit 30.

In the equivalent circuit diagram of the antenna device 100 in FIG. 4, the excitation electrode 52 and the slot 25 provide a slot antenna (second antenna). The excitation electrode 52 is electrically connected to the third outer electrode 13 of the antenna coupler 10, while the fourth outer electrode 14 of the antenna coupler 10 is connected to a GND (is grounded). That is, the antenna coupler 10 is connected in series with the excitation electrode 52 and the GND. The capacitor 60 is provided between the excitation electrode 52 and the third outer electrode 13.

The coils L1 and L2 are provided at positions at which they are magnetically coupled with each other in the antenna coupler 10. Mutual inductance M is generated between the coils L1 and L2. The antenna coupler 10 is a chip coil component formed by stacking multiple ceramic green sheets on each other. In the antenna device 100, it is not essential that the excitation electrodes 51 and 52 are connected to the antenna coupler 10, which is a chip coil component. The excitation electrodes 51 and 52 may simply be provided at positions at which the coils L1 and L2 are magnetically coupled with each other.

The characteristics of the antenna device 100 will now be described below. FIG. 5 is a graph illustrating the frequency characteristics of the antenna device 100 of the first example embodiment regarding the reflection coefficient. In FIG. 5, the horizontal axis indicates the frequency, and the vertical axis indicates the reflection coefficient (return loss). The reflection coefficient A is the reflection coefficient of the antenna coupler 10 seen from the feed circuit 30 in FIG. 4, that is, the reflection coefficient of the antenna device 100. The reflection coefficient A is a simulation result of the antenna device 100 when the inductance of the coil L1 is about 1.7 nH, the inductance of the coil L2 is about 1.1 nH, the coupling factor k is about 0.33, the capacitance of the capacitor 60 is about 0.3 pF, for example.

The reflection coefficient A shows that resonance is produced at mark M1 (about 2.5 GHz) at the resonant frequency of the fundamental wave of the antenna device 100. The reflection coefficient A also shows that resonance is produced at mark M2 (about 5.4 GHz) and mark M3 (about 6.6 GHz) at the resonant frequencies of harmonic waves of the antenna device 100. In the antenna device 100, as a result of coupling the slot antenna including the excitation electrode 52 with the slot antenna including the excitation electrode 51 by using the antenna coupler 10, more resonance points are provided so that resonance can be produced in a wider band including the band of about 5.0 to about 7.0 GHz, for example.

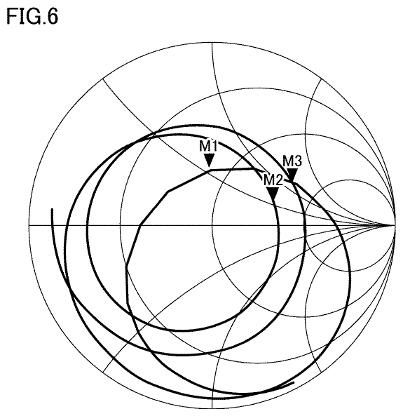

FIG. 6 is a Smith chart of the antenna device 100 of the first example embodiment. The Smith chart in FIG. 6 illustrates the impedance of the antenna device 100, which is adjusted by the provision of the capacitor 60 between the coil L2 and the excitation electrode 52 of the antenna device 100 shown in FIG. 4. The impedance of the antenna device 100 is adjusted also by setting the length of the excitation electrode 52 in the X direction to be shorter than that of the excitation electrode 51, as shown in FIG. 1.

In the Smith chart in FIG. 6, the lines of the target frequencies from about 2 GHz to about 8 GHz draw large circles near mark M1 (about 2.5 GHz), mark M2 (about 5.4 GHz), and mark M3 (about 6.6 GHz), for example. It is thus also seen from the Smith chart in FIG. 6 that the antenna device 100 can provide resonance points other than the resonance point at the resonant frequency (about 2.5 GHz) of the fundamental wave and produce resonance in a wider band including the band of about 5.0 GHz to about 7.0 GHz, for example.

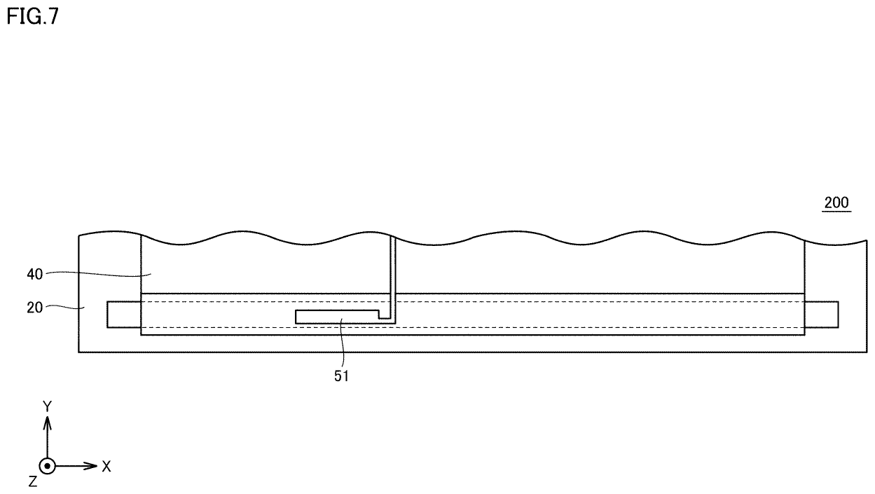

The characteristics of an antenna device of a comparative example will now be discussed below. FIG. 7 is a schematic view of an antenna device 200 of a comparative example. The antenna device 200 includes only one slot antenna including the excitation electrode 51. Unlike the antenna device 100, the antenna device 200 does not couple a slot antenna including the excitation electrode 52 with a slot antenna including the excitation electrode 51 by using the antenna coupler 10. An element of the antenna device 200 identical to the element of the antenna device 100 in FIG. 1 is designated by like reference numeral and a detailed explanation thereof will not be repeated.

In the antenna device 200, the excitation electrode 51 is provided at a position corresponding to the slot 25. The excitation electrode 51 is connected to the feed circuit 30 (not shown) via a line of the substrate 40 and receives power from the feed circuit 30. The slot antenna including the slot 25 and the excitation electrode 51 defines and functions as a feed antenna.

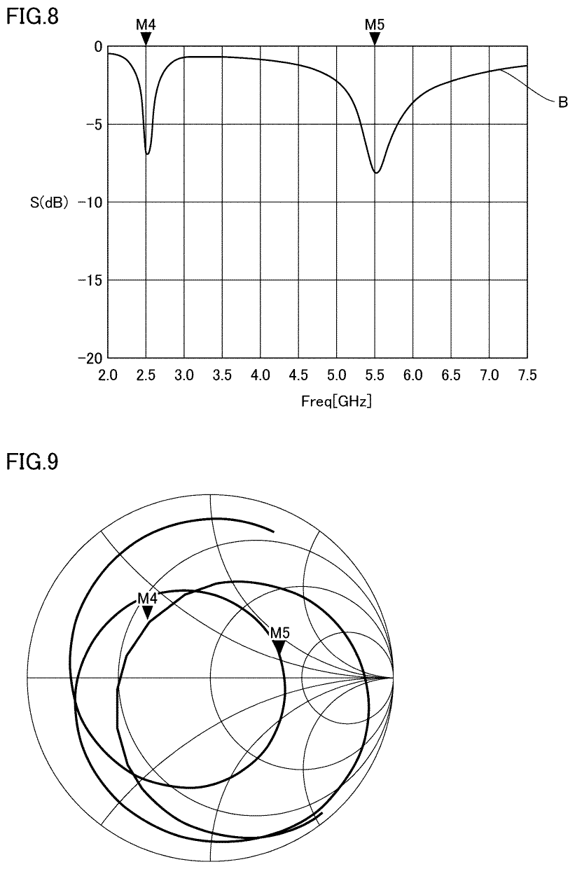

The characteristics of the antenna device 200 will now be described below. FIG. 8 is a graph illustrating the frequency characteristics of the antenna device 200 of the comparative example regarding the reflection coefficient. In FIG. 8, the horizontal axis indicates the frequency, and the vertical axis indicates the reflection coefficient (return loss). The reflection coefficient B is the reflection coefficient of the antenna device 200.

The reflection coefficient B shows that resonance is produced at mark M4 (about 2.5 GHz) at the resonant frequency of the fundamental wave of the antenna device 200. The reflection coefficient B also shows that resonance is produced at mark M5 (about 5.5 GHz) at the resonant frequency of a harmonic wave of the antenna device 200. The antenna device 200 merely produces resonance near the frequency of about 5.5 GHz, and unlike the antenna device 100, the antenna device 200 fails to produce resonance in a wide band including the band of about 5.0 GHz to about 7.0 GHz, for example.

FIG. 9 is a Smith chart of the antenna device 200 of the comparative example. In the Smith chart in FIG. 9, the lines of the target frequencies from 2 to 8 GHz draw large circles near mark M4 (about 2.5 GHz) and mark M5 (about 5.5 GHz). It is thus also seen from the Smith chart in FIG. 9 that the antenna device 200 produces resonance at about 5.5 GHz, as well as that at the resonant frequency (about 2.5 GHz) of the fundamental wave.

### Structure of Antenna Coupler

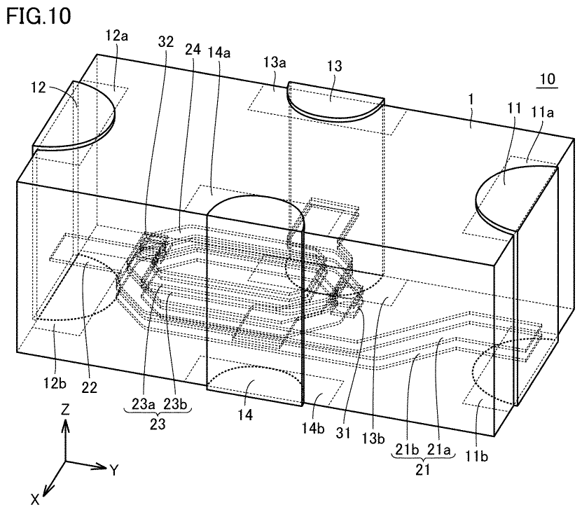

A description will now be given of the configuration of the antenna coupler 10 that couples the slot antenna including the excitation electrode 52 with the slot antenna including the excitation electrode 51. FIG. 10 is a perspective view of the antenna coupler 10 of the first example embodiment. FIG. 11 is a plan view of the antenna coupler 10 of the first example embodiment. In FIGS. 10 and 11, the direction of the short sides of the antenna coupler 10 is the X direction, the direction of the long sides is the Y direction, and the direction of the height is the Z direction. The stacking direction of substrates of the antenna coupler 10 is the Z direction, and the orientation of the arrow of the Z direction indicates the direction of a higher layer.

The antenna coupler 10 is a rectangular or substantially rectangular cuboid chip component that couples resonance produced by the excitation electrode 51 and that by the excitation electrode 52 with each other in the slot antenna. As illustrated in FIG. 10, a first outer electrode 11, a second outer electrode 12, a third outer electrode 13, and a fourth outer electrode 14 are provided on external surfaces of the antenna coupler 10. The antenna coupler 10 also includes a pair of main surfaces facing each other. The main surface on the lower side in FIG. 10 is the mounting surface to face a circuit substrate.

The antenna coupler 10 includes two coils L1 and L2 so as to magnetically couple resonance produced by the excitation electrode 51 and that by the excitation electrode 52 with each other in the slot antenna. The antenna coupler 10 provides a transformer including the magnetically coupled coils L1 and L2.

The specific configuration of the antenna coupler 10 will be explained below. As shown in FIGS. 10 and 11, the antenna coupler 10 includes an insulator 1 (ceramic base body) including ceramic layers, which are formed by stacking multiple substrates (ceramic green sheets) having the wiring of the coils formed thereon. The insulator 1 includes a pair of main surfaces facing each other and side surfaces which link the main surfaces with each other. Multiple first conductor patterns 21, a second conductor pattern 22, multiple third conductor patterns 23, and a fourth conductor pattern 24 are stacked on each other in parallel with the main surfaces of the insulator 1 so as to provide the antenna coupler 10 including the coils L1 and L2 therein.

The coil L1 is formed by stacking two layers of first conductor patterns 21a and 21b and one layer of the second conductor pattern 22 on each other and by electrically connecting these conductor patterns using a via-conductor 31. More specifically, the coil L1 is formed by connecting the two layers of the first conductor patterns 21, that is, the first conductor patterns 21a and 21b, in parallel with each other by using the via-conductor 31 and by connecting the second conductor pattern 22 in series with the two layers of the first conductor patterns 21 by using the via-conductor 31. With this configuration, the coil L1 can make the inductance components smaller than the configuration in which the first conductor pattern 21a and the second conductor pattern 22 are connected in series with each other. The first conductor patterns 21 may include two or more layers.

The coil L2 is formed by stacking two layers of third conductor patterns 23a and 23b and one layer of the fourth conductor pattern 24 on each other and by electrically connecting these conductor patterns using a via-conductor 32. More specifically, the coil L2 is formed by connecting the two layers of the third conductor patterns 23, that is, the third conductor patterns 23a and 23b, in parallel with each other by using the via-conductor 32 and by connecting the fourth conductor pattern 24 in series with the two layers of the third conductor patterns 23 by using the via-conductor 32. With this configuration, the coil L2 can make the inductance components smaller than the configuration in which the third conductor pattern 23a and the fourth conductor pattern 24 are connected in series with each other. The third conductor patterns 23 may include two or more layers.

The coils L1 and L2 are provided inside the insulator 1 so that the opening of the coil L1 and that of the coil L2 overlap each other as viewed from the stacking direction of the layers of the insulator 1. As shown in FIG. 11, as viewed from the stacking direction of the layers of the insulator 1, the opening of the coil L1 and that of the coil L2 are displaced from the center of the antenna coupler 10 in the direction of the long sides of the antenna coupler 10 and are located to approach the second outer electrode 12 provided on the short side of the antenna coupler 10. The arrangement of the coils L1 and L2 shown in FIG. 11 is only an example and the coils L1 and L2 may be arranged in a different manner. The coils L1 and L2 are provided in the insulator 1 so that the second conductor pattern 22 and the fourth conductor pattern 24 face each other. With this configuration, the single layer of the second conductor pattern 22 and the single layer of the fourth conductor pattern 24 face each other with an insulating layer interposed therebetween. This can make the capacitance components of the coils L1 and L2 smaller than the configuration in which three layers of conductor patterns face each other with an insulating layer interposed therebetween.

With the above-described arrangement of the coils L1 and L2 in which the second and fourth conductor patterns 22 and 24 face each other, a high coupling factor between the coils L1 and L2 can be maintained compared with the configuration in which the two layers of the first conductor patterns 21 and the two layers of the third conductor patterns 23 face each other. In the antenna coupler 10, with the arrangement of the coils L1 and L2 in which the second and fourth conductor patterns 22 and 24 face each other, the mutual inductance M between the coils L1 and L2 is not lowered.

As illustrated in FIG. 10, on the side surfaces of the insulator 1, the first outer electrode 11 is provided on one short side, the second outer electrode 12 is provided on another short side, the third outer electrode 13 is provided on one long side, and the fourth outer electrode 14 is provided on another long side.

Each of the first conductor patterns 21 is electrically connected to the first outer electrode 11. Alternatively, among the first conductor patterns 21, only the first conductor pattern 21b of the lower layer may be electrically connected to the first outer electrode 11, and the first conductor pattern 21a of the upper layer may be electrically connected to the first conductor pattern 21b using a via-conductor. The second conductor pattern 22 is electrically connected to the second outer electrode 12.

Each of the third conductor patterns 23 is electrically connected to the third outer electrode 13. Alternatively, among the third conductor patterns 23, only the third conductor pattern 23b of the lower layer may be electrically connected to the third outer electrode 13, and the third conductor pattern 23a of the upper layer may be electrically connected to the third conductor pattern 23b using a via-conductor. The fourth conductor pattern 24 is electrically connected to the fourth outer electrode 14.

### Exploded Plan Views of Antenna Coupler

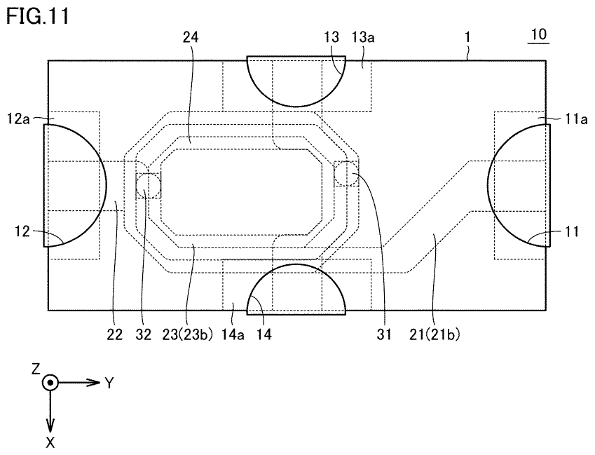

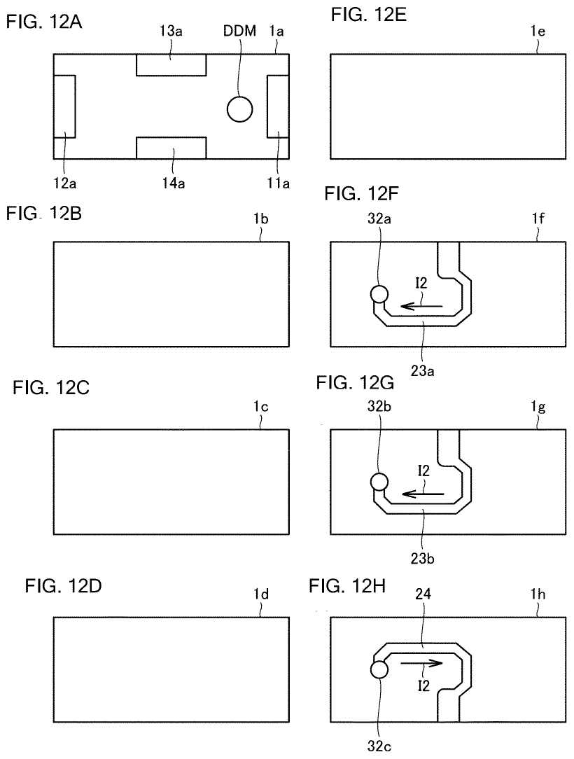

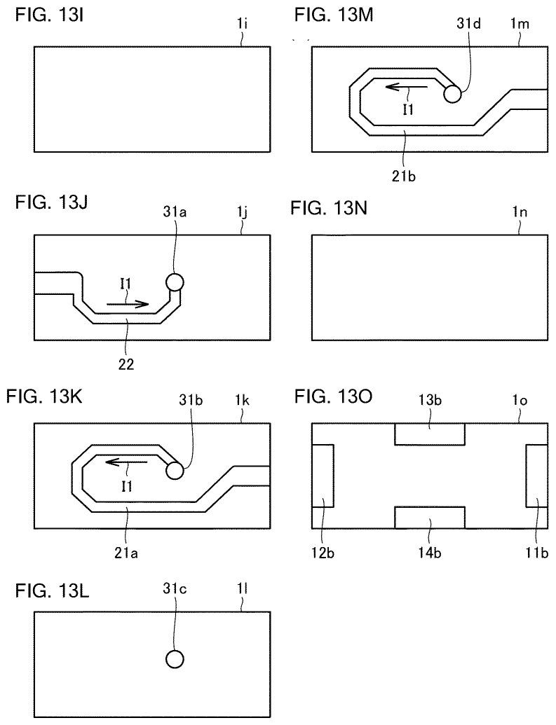

The configurations of the individual layers of the antenna coupler 10 will be described below by using exploded plan views. FIGS. 12A to 12H are first exploded plan views illustrating the configuration of the antenna coupler 10 of the first example embodiment. FIGS. 13I to 13M are second exploded plan views illustrating the configuration of the antenna coupler 10 of the first example embodiment. As shown in FIGS. 12 and 13, to form the first through fourth conductor patterns 21 through 24, a conductive paste (Ni paste) is applied to ceramic green sheets 1a through 10, which are substrates, by screen printing to form conductor patterns.

On the ceramic green sheet 1a, conductor patterns 11a through 14a are formed at positions corresponding to the first through fourth outer electrodes 11 through 14, as shown in FIG. 12A. A direction identification mark DDM is appended to the ceramic green sheet 1a to indicate that the ceramic green sheet 1a is the top surface, which is the opposite side of the mounting surface. The direction identification mark DDM is used for determining the orientation of a chip component, such as the antenna coupler 10, when mounting the chip component on a circuit substrate by a mounting machine. On the ceramic green sheets 1b through le, no conductor pattern is formed, as shown in FIGS. 12B through 12E.

On the ceramic green sheet lf, the third conductor pattern 23a is formed, as shown in FIG. 12F. The third conductor pattern 23a is formed to turn clockwise from the center of the upper long side of the ceramic green sheet 1f in FIG. 12F by about ½ to about ¾ turns, for example. The start edge of the third conductor pattern 23a is formed at the outer periphery of the ceramic green sheet If so as to electrically connect to the third outer electrode 13. A connecting portion 32a to connect to the via-conductor 32 is provided at the end edge of the third conductor pattern 23a.

On the ceramic green sheet 1g, the third conductor pattern 23b is formed, as shown in FIG. 12G. The third conductor pattern 23b is formed to turn clockwise from the center of the upper long side of the ceramic green sheet 1g in FIG. 12G by about ½ to about ¾ turns, for example. The start edge of the third conductor pattern 23b is formed at the outer periphery of the ceramic green sheet 1g so as to electrically connect to the third outer electrode 13. A connecting portion 32b to connect to the via-conductor 32 is provided at the end edge of the third conductor pattern 23b.

On the ceramic green sheet 1h, the fourth conductor pattern 24 is formed, as shown in FIG. 12H. The fourth conductor pattern 24 is formed to turn counterclockwise from the center of the lower long side of the ceramic green sheet 1h in FIG. 12H by about ½ to about ¾ turns, for example. The start edge of the fourth conductor pattern 24 is formed at the outer periphery of the ceramic green sheet 1h so as to electrically connect to the fourth outer electrode 14. A connecting portion 32c to connect to the via-conductor 32 is provided at the end edge of the fourth conductor pattern 24.

On the ceramic green sheet 1i, no conductor pattern is formed, as shown in FIG. 13I. That is, in the antenna coupler 10, the interlayer distance between the fourth conductor pattern 24 and the second conductor pattern 22 is longer than that between the third conductor patterns 23a and 23b or that between the third conductor pattern 23b and the fourth conductor pattern 24. In this manner, in the antenna coupler 10, adjusting the interlayer distance between the fourth conductor pattern 24 and the second conductor pattern 22 can control the coupling degree between the coils L1 and L2.

On the ceramic green sheet 1j, the second conductor pattern 22 is formed, as shown in FIG. 13J. The second conductor pattern 22 is formed to turn counterclockwise from the center of the left short side of the ceramic green sheet 1j in FIG. 13J by about ½ turns, for example. The start edge of the second conductor pattern 22 is formed at the outer periphery of the ceramic green sheet 1j so as to electrically connect to the second outer electrode 12. A connecting portion 31a to connect to the via-conductor 31 is provided at the end edge of the second conductor pattern 22.

On the ceramic green sheet 1k, the first conductor pattern 21a is formed, as shown in FIG. 13K. The first conductor pattern 21a is formed to turn clockwise from the center of the right short side of the ceramic green sheet 1k in FIG. 13K by about ¾ turns to one turn. The start edge of the first conductor pattern 21a is formed at the outer periphery of the ceramic green sheet 1k so as to electrically connect to the first outer electrode 11. A connecting portion 31b to connect to the via-conductor 31 is provided at the end edge of the first conductor pattern 21a.

On the ceramic green sheet 11, a connecting portion 31c to connect to the via-conductor 31 is only provided and no conductor pattern is formed, as shown in FIG. 13L. That is, in the antenna coupler 10, the interlayer distance between the first conductor patterns 21a and 21b is longer than that between the third conductor patterns 23a and 23b or that between the first conductor pattern 21a and the second conductor pattern 22. The first conductor pattern 21b is a first conductor pattern which faces the second conductor pattern 22 among the multiple first conductor patterns 21. In this manner, in the antenna coupler 10, adjusting the interlayer distance between the first conductor patterns 21a and 21b can control the inductance components of the coil L1.

On the ceramic green sheet 1m, the first conductor pattern 21b is formed, as shown in FIG. 13M. The first conductor pattern 21b is formed to turn clockwise from the center of the right short side of the ceramic green sheet 1m in FIG. 13M by about ¾ turns to about one turn, for example. The start edge of the first conductor pattern 21b is formed at the outer periphery of the ceramic green sheet 1m so as to electrically connect to the first outer electrode 11. A connecting portion 31d to connect to the via-conductor 31 is provided at the end edge of the first conductor pattern 21b.

On the ceramic green sheet 1n, no conductor pattern is formed, as shown in FIG. 13N. On the ceramic green sheet 10, conductor patterns 11b through 14b are formed at positions corresponding to the first through fourth outer electrodes 11 through 14, as shown in FIG. 13O.

It has been explained that the substrates forming the insulator 1 are ceramic green sheets. However, the insulator 1 may be a non-magnetic ceramic insulator formed of LTCC (LOW Temperature Co-fired Ceramics), for example, or a resin insulator made of a resin material, such as a polyimide or a liquid crystal polymer. In this manner, by the use of a non-magnetic substance for the substrates forming the insulator 1 instead of using magnetic ferrite, the antenna coupler 10 is capable of functioning as an antenna coupler even in a high-frequency range exceeding several hundred of megahertz.

The conductor patterns and via-conductors are made of a conductive material having a small specific resistance using Ag or Cu as the primary component. If the substrates forming the insulator 1 are made of a ceramic material, a conductive paste using Ag or Cu as the primary component is applied to form the conductor patterns and via-conductors by screen printing or firing, for example. If the substrates forming the insulator 1 are made of a resin material, a metal foil, such as an Al foil or a Cu foil, is patterned by etching to form the conductor patterns and via-conductors, for example. The antenna coupler 10 shown in FIGS. 10 through 13 is only an example. The antenna coupler 10 may be configured in a different manner if it includes at least two coils L1 and L2 and provides a transformer including the coils L1 and L2 magnetically coupled with each other. For example, the antenna coupler 10 may include, among the conductor patterns of the coil L1, a conductor pattern that is not electrically connected to the first outer electrode 11 or the second outer electrode 12 and may include, among the conductor patterns of the coil L2, a conductor pattern that is not electrically connected to the third outer electrode 13 or the fourth outer electrode 14.

### Coupling of Two Antennas Using Antenna Coupler

In the antenna device 100, the slot antenna including the excitation electrode 52 is coupled with the slot antenna including the excitation electrode 51 by using the antenna coupler 10. That is, in the antenna device 100, resonance produced by the excitation electrode 51 and that by the excitation electrode 52 are magnetically coupled with each other in the slot antenna by using the coils L1 and L2 forming a transformer. This will be explained more specifically. The feed circuit 30 is connected to the second outer electrode 12 of the antenna coupler 10, and the excitation electrode 51 is connected to the first outer electrode 11. Hence, when power is fed from the feed circuit 30 to the excitation electrode 51, a current Il flows through the first conductor patterns 21a and 21b and the second conductor pattern 22. The current I1 flows through the second conductor pattern 22 toward the connecting portion 31a, as indicated by the arrow in FIG. 13J, and flows through the first conductor patterns 21a and 21b to separate from the connecting portions 31b and 31d, as indicated by the arrows in FIGS. 13K and FIG. 13M. A current I2 flows through the coil L2, which forms the transformer, to generate a magnetic field to cancel out the magnetic field generated in the coil L1 by the current I1. That is, the current I2 flows through the third conductor patterns 23a and 23b toward the connecting portions 32a and 32b, as indicated by the arrows in FIGS. 12F and 12G, and flows through the fourth conductor pattern 24 to separate from the connecting portion 32c, as indicated by the arrow in FIG. 12H.

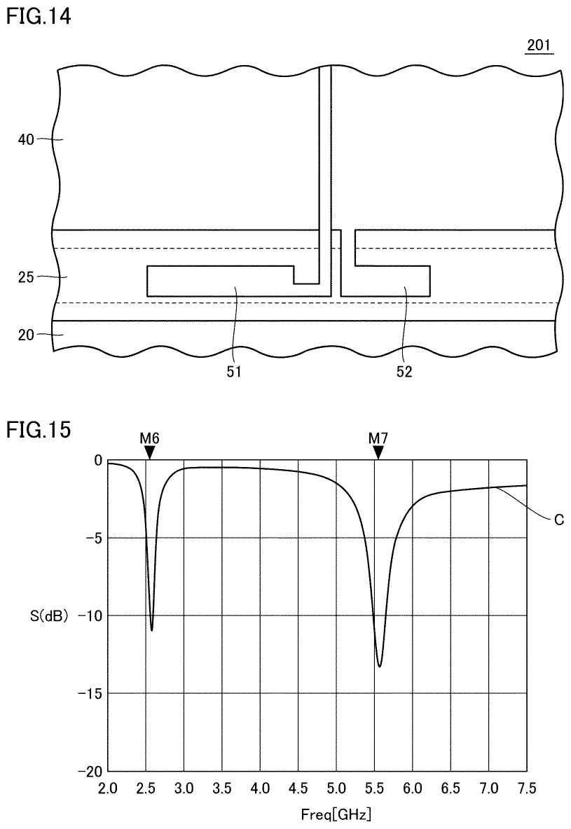

In this manner, as a result of coupling the slot antenna including the excitation electrode 52 with the slot antenna including the excitation electrode 51 by using the antenna coupler 10, the antenna device 100 is able to provide more resonance points and produce resonance in a wider band. This advantage will be explained below by comparison with an antenna device of another comparative example. FIG. 14 is a schematic view of an antenna device 201 of another comparative example. Unlike the antenna device 100, in the antenna device 201, the excitation electrodes 51 and 52 are not connected to the antenna coupler 10, but are connected in parallel with the substrate 40. An element of the antenna device 201 identical to the corresponding element of the antenna device 100 in FIG. 1 is designated by like reference numeral and a detailed explanation thereof will not be repeated.

In the antenna device 201, the excitation electrodes 51 and 52 are provided at positions corresponding to the slot 25. The excitation electrode 51 is not connected to the antenna coupler 10, but is connected to the feed circuit 30 (not shown) via a line of the substrate 40 and receives power from the feed circuit 30. The excitation electrode 52 is not connected to the antenna coupler 10, but is connected to the substrate 40 and to a GND (is grounded). That is, in the antenna device 201, a slot antenna including the slot 25 and the excitation electrode 51 defines and functions as a feed antenna, while a slot antenna including the slot 25 and the excitation electrode 52 defines and functions as a parasitic antenna. However, the excitation electrodes 51 and 52 are merely electrically coupled with each other, but are not magnetically coupled with each other.

The characteristics of the antenna device 201 will now be described below. FIG. 15 is a graph illustrating the frequency characteristics of the antenna device 201 of the comparative example regarding the reflection coefficient. In FIG. 15, the horizontal axis indicates the frequency, and the vertical axis indicates the reflection coefficient (return loss). The reflection coefficient C is the reflection coefficient of the antenna device 201.

The reflection coefficient C shows that resonance is produced at mark M6 (about 2.6 GHz) at the resonant frequency of the fundamental wave of the antenna device 201. The reflection coefficient C also shows that resonance is produced at mark M7 (about 5.6 GHz) at the resonant frequency of a harmonic wave of the antenna device 201. The antenna device 201 merely produces resonance near the frequency of about 5.6 GHz, and unlike the antenna device 100, the antenna device 201 fails to provide more resonance points and to produce resonance in a wide band including the band of about 5.0 to about 7.0 GHz, for example.

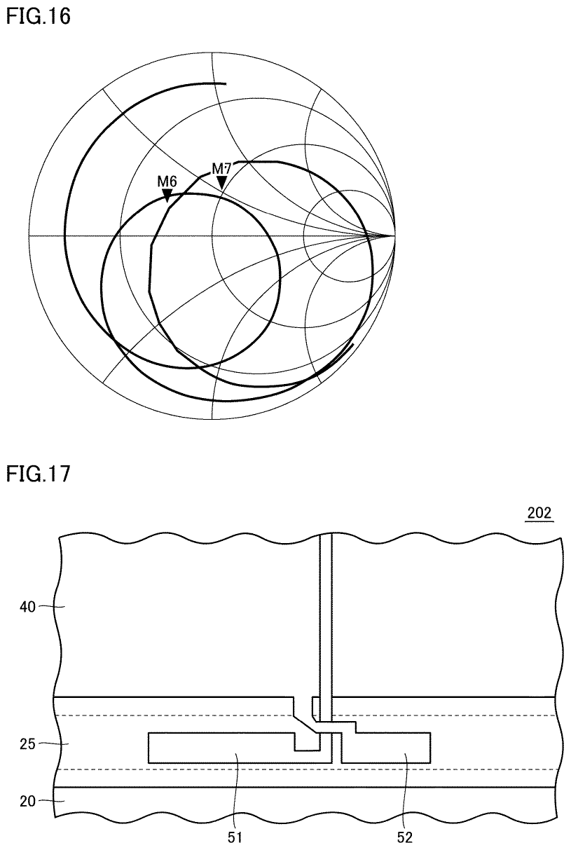

FIG. 16 is a Smith chart of the antenna device 201 of the comparative example. In the Smith chart in FIG. 16, the lines of the target frequencies from, for example, about 2 GHz to about 8 GHz draw large circles near mark M6 (about 2.6 GHz) and mark M7 (about 5.6 GHz). It is thus also seen from the Smith chart in FIG. 16 that the antenna device 201 merely produces resonance at about 5.6 GHz, as well as that at the resonant frequency (about 2.6 GHz) of the fundamental wave.

FIG. 17 is a schematic view of an antenna device 202 of another comparative example. Unlike the antenna device 100, in the antenna device 202, the excitation electrodes 51 and 52 are not connected to the antenna coupler 10, but a connecting portion of the excitation electrode 51 and that of the excitation electrode 52 intersect with each other and are connected to the substrate 40. An element of the antenna device 202 identical to the corresponding element of the antenna device 100 in FIG. 1 is designated by like reference numeral and a detailed explanation thereof will not be repeated.

In the antenna device 202, the excitation electrodes 51 and 52 are provided at positions corresponding to the slot 25. The excitation electrode 51 is not connected to the antenna coupler 10, but is connected to the feed circuit 30 (not shown) via a line of the substrate 40 and receives power from the feed circuit 30. The excitation electrode 52 is not connected to the antenna coupler 10, but passes over the connecting portion of the excitation electrode 51 and is connected to the substrate 40 and to a GND (is grounded). That is, in the antenna device 202, a slot antenna including the slot 25 and the excitation electrode 51 defines and functions as a feed antenna, while a slot antenna including the slot 25 and the excitation electrode 52 defines and functions as a parasitic antenna. However, the excitation electrodes 51 and 52 are merely electrically coupled with each other by their connecting portions intersecting with each other, but are not magnetically coupled with each other.

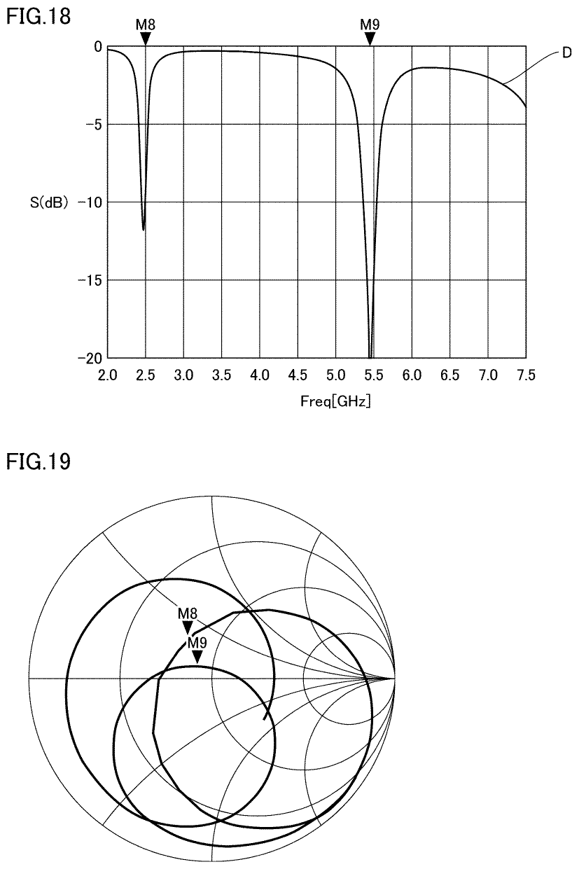

The characteristics of the antenna device 202 will now be described below. FIG. 18 is a graph illustrating the frequency characteristics of the antenna device 202 of the comparative example regarding the reflection coefficient. In FIG. 18, the horizontal axis indicates the frequency, and the vertical axis indicates the reflection coefficient (return loss). The reflection coefficient D is the reflection coefficient of the antenna device 202.

The reflection coefficient D shows that resonance is produced at mark M8 (about 2.5 GHz) at the resonant frequency of the fundamental wave of the antenna device 202. The reflection coefficient D also shows that resonance is produced at mark M9 (about 5.5 GHz) at the resonant frequency of a harmonic wave of the antenna device 202. The antenna device 202 merely produces resonance near the frequency of, for example, about 5.5 GHz, and unlike the antenna device 100, the antenna device 202 fails to provide more resonance points and to produce resonance in a wide band including the band of about 5.0 to 7.0 GHz.

FIG. 19 is a Smith chart of the antenna device 202 of the comparative example. In the Smith chart in FIG. 19, the lines of the target frequencies from about 2 GHz to about 8 GHz draw large circles near mark M8 (about 2.5 GHz) and mark M9 (about 5.5 GHz), for example. It is thus also seen from the Smith chart in FIG. 19 that the antenna device 202 merely produces resonance at about 5.5 GHz, as well as that at the resonant frequency (about 2.5 GHz) of the fundamental wave.

It is seen from the antenna devices 201 and 202 of the comparative examples that merely adding a slot antenna which functions as a parasitic antenna to a slot antenna which functions as a feed antenna is unable to provide more resonance points and to produce resonance in a wide band. In the antenna device 100, therefore, as a result of coupling the slot antenna including the excitation electrode 52 with the slot antenna including the excitation electrode 51 by using the antenna coupler 10, the advantage of providing more resonance points and producing resonance in a wide band is achieved.

### Impedance Adjustment

In the antenna device 100, as a result of adjusting the impedance of the slot antenna including the excitation electrode 52 to be coupled with the slot antenna including the excitation electrode 51 by using the antenna coupler 10, the frequency characteristics in the vicinity of an added resonance point can be modified so as to change the width of a band in which resonance is produced. As the approach to adjusting the impedance of the slot antenna including the excitation electrode 52, the length of the excitation electrode 52 in the X direction may be changed, or the capacitance of the capacitor 60 connected between the coil L2 and the excitation electrode 52 may be changed, for example.

In the antenna device 100, the length of the excitation electrode 52 in the X direction is set to be about half of that of the excitation electrode 51, and the capacitance of the capacitor 60 is set to be about 0.3 pF, for example, to adjust the impedance. Changing of the frequency characteristics in the vicinity of an added resonance point by adjusting the impedance in this manner will be explained. Specifically, an explanation will be given of the characteristics of the antenna device 100 after the impedance is adjusted by setting the capacitance of the capacitor 60 to be 0 (zero) F.

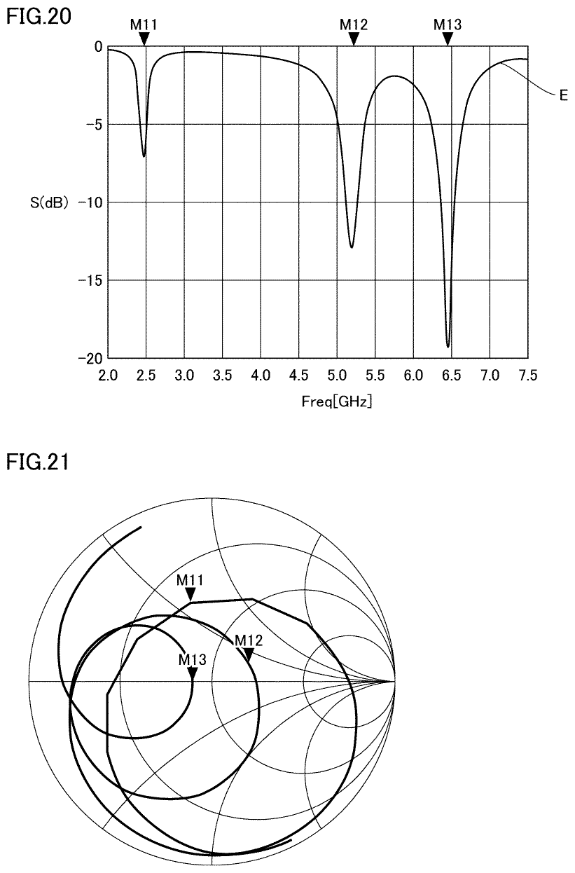

FIG. 20 is a graph illustrating the frequency characteristics of the antenna device 100 regarding the reflection coefficient after the capacitance of the capacitor is changed. In FIG. 20, the horizontal axis indicates the frequency, and the vertical axis indicates the reflection coefficient (return loss). The reflection coefficient E is the reflection coefficient of the antenna device 100 in which the capacitance of the capacitor 60 is changed to 0 (zero) F.

The reflection coefficient E shows that resonance is produced at mark M11 (about 2.5 GHz) at the resonant frequency of the fundamental wave of the antenna device 100. The reflection coefficient E also shows that resonance is produced at mark M12 (about 5.2 GHz) and mark M13 (about 6.5 GHz) at the resonant frequencies of harmonic waves of the antenna device 100. Even after the capacitance of the capacitor 60 is changed to 0 (zero) F, the antenna device 100 can provide more resonance points. As is seen from the reflection coefficient E, however, resonance is produced only near the mark M12 (about 5.2 GHz) and mark M13 (about 6.5 GHz), and unlike the reflection coefficient A shown in FIG. 5, the antenna device 100 fails to produce resonance in a wide band including the band of about 5.0 GHz to about 7.0 GHz, for example.

FIG. 21 is a Smith chart of the antenna device 100 in which the capacitance of the capacitor is changed. In the Smith chart in FIG. 21, the lines of the target frequencies from about 2 GHz to about 8 GHz draw circles near mark M11 (about 2.5 GHz), mark M12 (about 5.2 GHz), and mark M13 (about 6.5 GHz), for example. In the Smith chart in FIG. 21, however, the circles near the mark M12 (about 5.2 GHz) and mark M13 (about 6.5 GHz) are smaller than the large circles near the mark M2 and mark M3 in the Smith chart in FIG. 6. It is thus also seen from the Smith chart in FIG. 21 that the antenna device 100 in which the capacitance of the capacitor 60 is changed to 0 (zero) F fails to produce resonance in a wide band including the band of about 5.0 GHz to about 7.0 GHz, for example, though it can provide more resonance points.

### Modified Examples

In the antenna device 100 described above, as illustrated in FIG. 3, the excitation electrodes 51 and 52 are positioned on the substrate 40 provided on the conductor 20 so that they do not directly overlap the slot 25 in the Z direction. However, the excitation electrodes 51 and 52 may be provided at positions at which they overlap the slot 25 in the Z direction.

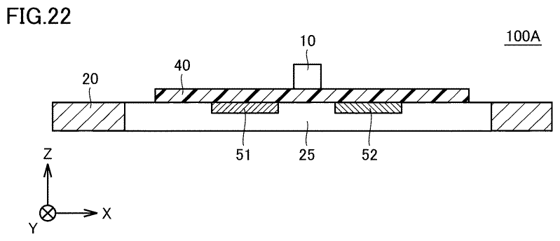

FIG. 22 is a sectional view of an antenna device 100A according to a modified example. An element of the antenna device 100A identical to the corresponding element of the antenna device 100 in FIGS. 1 through 3 is designated by like reference numeral and a detailed explanation thereof will not be repeated. As illustrated in FIG. 3, in the antenna device 100, the excitation electrodes 51 and 52 are formed on the surface of the substrate 40, which is the opposite side of the surface of the substrate 40 contacting the conductor 20. In contrast, in the antenna device 100A, as illustrated in FIG. 22, the excitation electrodes 51 and 52 are formed on the surface of the substrate 40 which contacts the conductor 20. That is, in the antenna device 100A, the excitation electrodes 51 and 52 are provided at positions at which they overlap the slot 25 in the Z direction. In the example in FIG. 22, the antenna coupler 10 is provided at a position at which it does not overlap the conductor 20 in the Z direction. However, as in the excitation electrodes 51 and 52, the antenna coupler 10 may also be provided at a position at which it overlaps the slot 25 in the Z direction. The excitation electrodes 51 and 52 may be provided on different surfaces of the substrate 40.

### Second Example Embodiment

In the antenna device 100 according to the first example embodiment, the slot 25 elongated in the X direction is provided in the planar conductor 20, and the excitation electrodes 51 and 52 are provided at positions corresponding to the slot 25. Since the excitation electrodes 51 and 52 are provided along the long side 25a of the slot 25, they are electrically (capacitively) coupled with the peripheral portion of the slot 25, such that the excitation electrodes 51 and 52 and the peripheral portion of the slot 25 are excited as an antenna. In an antenna device according to a second example embodiment, to widen the frequency band to be used, an antenna excited by causing a current to flow in the peripheral portion of a slot is combined with an antenna excited by electrically coupling an excitation electrode and the peripheral portion of the slot with each other.

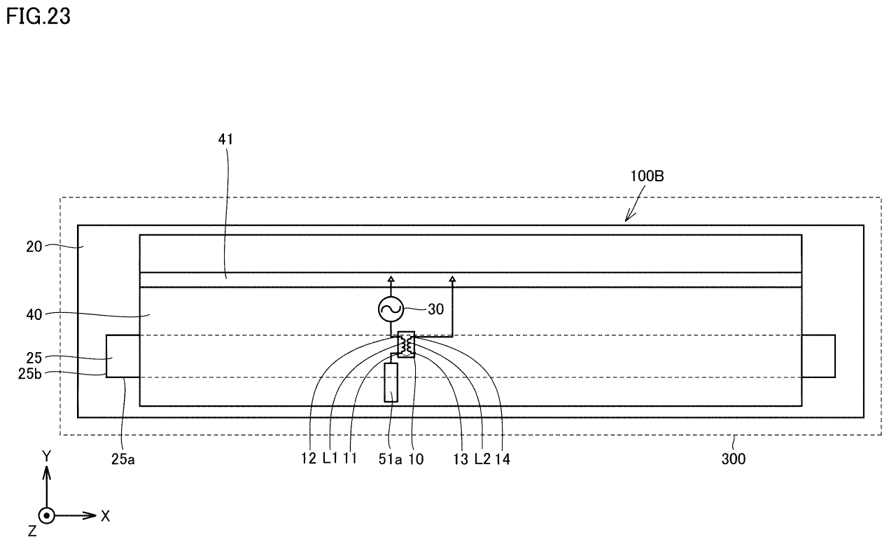

FIG. 23 is a schematic view of an electronic apparatus including an antenna device 100B of the second example embodiment. As illustrated in FIG. 23, the electronic apparatus includes the antenna device 100B, a feed circuit 30 that feeds power to an excitation electrode 51a (first excitation electrode), and a housing 300 that houses the antenna device 100B and the feed circuit 30. An element of the electronic apparatus including the antenna device 100B identical to the corresponding element of the electronic apparatus including the antenna device 100 in FIG. 1 is designated by like reference numeral and a detailed explanation thereof will not be repeated.

In the antenna device 100B, a slot 25 elongated in the X direction is provided in a planar conductor 20, and the excitation electrode 51a (also be simply called an excitation conductor, a feed line, or a microstrip line) is provided near the slot 25. That is, in the antenna device 100B, the excitation electrode 51a operates as a capacitor feed element with respect to the slot 25, and the excitation electrode 51a and the peripheral portion of the slot 25 are electrically (capacitively) coupled with each other so as to be excited as a slot antenna.

The excitation electrode 51a is electrically connected to one end (first outer electrode 11) of a coil L1 of an antenna coupler 10 mounted on a substrate 40. As shown in FIG. 23, the excitation electrode 51a is connected to the feed circuit 30 via the antenna coupler 10 and receives power from the feed circuit 30. That is, the slot antenna including the slot 25 and the excitation electrode 51a defines and functions as a feed antenna. The other end (second outer electrode 12) of the coil L1 of the antenna coupler 10 is electrically connected to the feed circuit 30.

Unlike the antenna device 100, the antenna device 100B does not include the excitation electrode 52, and one end (fourth outer electrode 14) of the coil L2 of the antenna coupler 10 is connected to a GND electrode 41 (substrate electrode) of the substrate 40. In the antenna device 100B, as a result of connecting one end of the coil L2 to the GND electrode 41, a current flows from the feed circuit 30 to the peripheral portion of the slot 25 via the coil L1, which is magnetically coupled with the coil L2, whereby the antenna device 100B is excited as an antenna. As a result, the antenna device 100B can have the resonant frequency of the antenna which is excited by the connection between the antenna coupler 10 and the GND electrode 41, as well as the resonant frequency of the slot antenna which is excited by the excitation electrode 51a, thus making it possible to widen the frequency band to be used.

The other end (third outer electrode 13) of the coil L2 may be connected to the substrate 40 or may be disconnected therefrom. The other end of the coil L2 is not electrically connected to any electrode including a GND electrode. Connecting the other end of the coil L2 to the substrate 40 can enhance the mounting strength of the antenna coupler 10 onto the substrate 40.

The GND electrode 41 shown in FIG. 23 has a strip-like shape provided in the X direction of the substrate 40 in parallel with the slot 25. However, the GND electrode 41 is not limited to this shape and may be formed in another shape if the GND electrode 41 can connect one end of the feed circuit 30 and one end of the coil L2 thereto. The GND electrode 41 may be separately defined by a portion electrically connected to one end of the feed circuit 30 and a portion electrically connected to one end of the coil L2. In this case, these portions of the GND electrode 41 are electrically connected to the conductor 20 provided on the housing 300.

In the antenna device 100B, as a result of connecting one end of the coil L2 to the GND electrode 41, a current flows from the feed circuit 30 to the peripheral portion of the slot 25 via the coil L1, which is magnetically coupled with the coil L2, such that the antenna device 100B is excited as an antenna. Hence, in accordance with the relationship between the position at which one end of the feed circuit 30 is electrically connected to the GND electrode 41 and the position at which one end of the coil L2 is electrically connected to the GND electrode 41, the magnitude of a current flowing through the peripheral portion of the slot 25 is changed, and the resonant frequency of the antenna to be excited by the current is also changed.

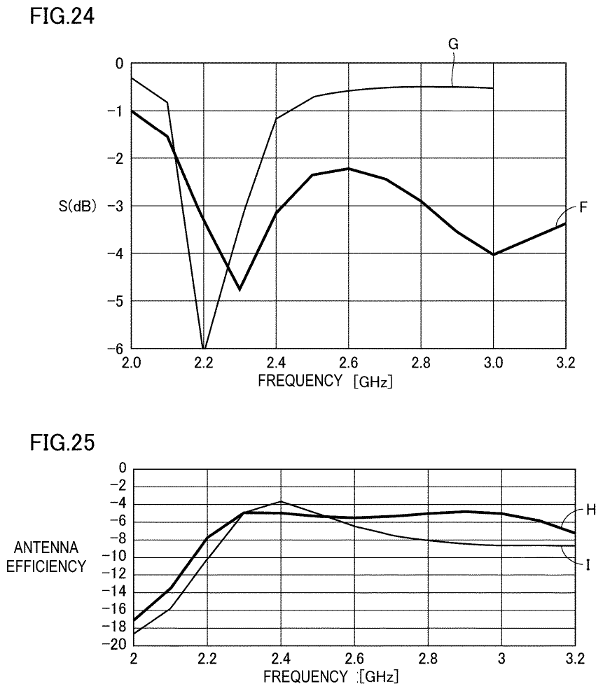

The simulation results of the antenna device 100B will now be described below. FIG. 24 is a graph illustrating the frequency characteristics of the antenna device 100B of the second example embodiment regarding the reflection coefficient. FIG. 25 is a graph illustrating the antenna efficiency of the antenna device 100B of the second example embodiment. In FIG. 24, the horizontal axis indicates the frequency, and the vertical axis indicates the reflection coefficient (return loss). In FIG. 25, the horizontal axis indicates the frequency, and the vertical axis indicates the antenna efficiency.

The reflection coefficient F in FIG. 24 is the reflection coefficient of the antenna device 100B. The reflection coefficient G is the reflection coefficient of a slot antenna without an antenna coupler. The reflection coefficient F shows that resonance is produced at about 2.3 GHz, which is the resonant frequency of the slot antenna excited by the excitation electrode 51a. The reflection coefficient F shows that resonance is also produced at about 3.0 GHz, which is the resonant frequency of the antenna excited by the connection between the antenna coupler 10 and the GND electrode 41. The antenna efficiency H of the antenna device 100B shown in FIG. 25 thus maintains high efficiency in the range of about 2.3 GHz to about 3.0 GHz, for example.

In FIGS. 24 and 25, the reflection coefficient G and the antenna efficiency I of an antenna device only provided with a slot antenna excited by an excitation electrode are shown as a comparative example. The reflection coefficient G shows that resonance is produced only at about 2.2 GHz, for example, which is the resonant frequency of the slot antenna excited by the excitation electrode, and no other resonance point is produced. It is thus seen from the antenna efficiency I in FIG. 25 that the efficiency becomes lower as the frequency becomes higher in excess of about 2.4 GHz, for example.

As is seen from the simulation results in FIGS. 24 and 25, as a result of adding the antenna excited by the connection between the antenna coupler 10 and the GND electrode 41 to the slot antenna excited by the excitation electrode 51a, the antenna device 100B is able to provide more resonance points and to produce resonance in a wide band including the range of about 2.3 GHz to about 3.0 GHz, for example. The antenna device 100B is also able to obtain high antenna efficiency in a wide band.

### First Modified Example

In the antenna device 100B shown in FIG. 23, the position at which one end of the feed circuit 30 is electrically connected to the GND electrode 41 and the position at which one end of the coil L2 is electrically connected to the GND electrode 41 are located on the same side of the slot 25. In an antenna device of a first modified example, the position at which one end of the feed circuit is electrically connected to the GND electrode and the position at which one end of the coil L2 is electrically connected to the GND electrode are located on different sides of the slot 25.

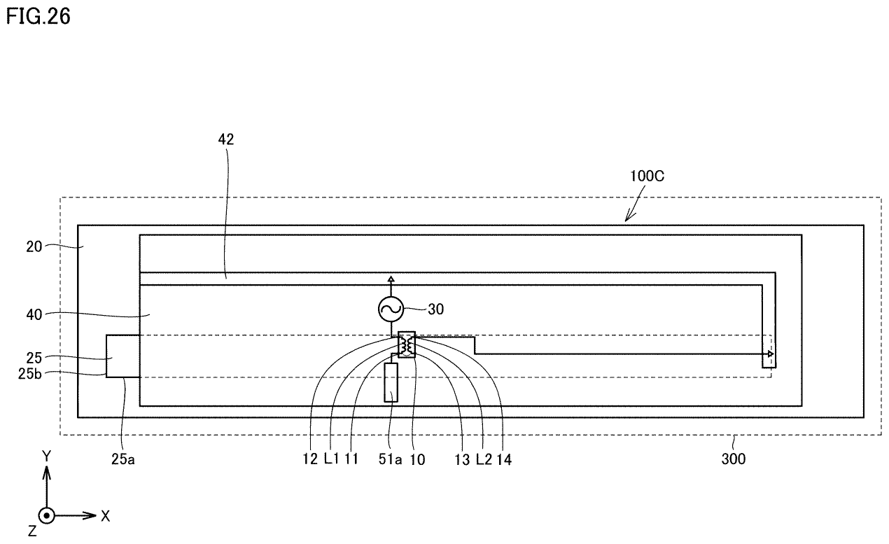

FIG. 26 is a schematic view of an electronic apparatus including an antenna device 100C of the first modified example of the second example embodiment. As illustrated in FIG. 26, the electronic apparatus includes the antenna device 100C, a feed circuit 30 that feeds power to an excitation electrode 51a (excitation electrode), and a housing 300 that houses the antenna device 100C and the feed circuit 30. An element of the electronic apparatus including the antenna device 100C identical to the corresponding element of the electronic apparatus including the antenna device 100 in FIG. 1 and that of the electronic apparatus including the antenna device 100B in FIG. 23 is designated by like reference numeral and a detailed explanation thereof will not be repeated.

In the antenna device 100C, a slot 25 elongated in the X direction is provided in a planar conductor 20, and the excitation electrode 51a is provided near the slot 25. That is, in the antenna device 100C, the excitation electrode 51a operates as a capacitor feed element with respect to the slot 25, and the excitation electrode 51a and the peripheral portion of the slot 25 are electrically (capacitively) coupled with each other so as to be excited as a slot antenna. The slot antenna including the slot 25 and the excitation electrode 51a defines and functions as a feed antenna.

In the antenna device 100C, one end (fourth outer electrode 14) of the coil L2 is connected to a GND electrode 42 (substrate electrode) of the substrate 40. In the antenna device 100C, as a result of connecting one end of the coil L2 to the GND electrode 42, a current flows from the feed circuit 30 to the peripheral portion of the slot 25 via the coil L1, which is magnetically coupled with the coil L2, such that the antenna device 100C is excited as an antenna.

The GND electrode 42 shown in FIG. 26 has an L-like shape including a portion which is provided in the X direction of the substrate 40 in parallel with the slot 25 and a portion which is provided in the Y direction of the substrate 40 and which overlaps the slot 25. Since the slot 25 and the GND electrode 42 overlap each other as viewed in the Z direction, the slot of the slot antenna is the slot 25 except for the portion where the slot 25 and the GND electrode 42 overlap each other. Although the GND electrode 42 overlaps the slot 25 as viewed in the Z direction in the example in FIG. 26, it may have an L-like shape without overlapping the slot 25 as viewed in the Z direction.

In the antenna device 100C, the position at which one end of the feed circuit 30 is electrically connected to the GND electrode 42 and the position at which one end of the coil L2 is electrically connected to the GND electrode 42 are located on different sides of the slot 25. More specifically, the end of the feed circuit 30 connected to the GND electrode 42 is located on a side of the slot 25 in the X direction of the GND electrode 42, while the end of the coil L2 connected to the GND electrode 42 is located on a side of the slot 25 in the Y direction of the GND electrode 42. In the antenna device 100C, the position at which one end of the coil L2 is electrically connected to the GND electrode 42 is separated from the position at which one end of the feed circuit 30 is electrically connected to the GND electrode 42. This can prevent the interference of the resonance of one antenna and that of the other antenna, thereby improving the antenna characteristics.

The GND electrode 42 may be separately defined by an electrode which is electrically connected to one end of the feed circuit 30 and an electrode which is electrically connected to one end of the coil L2. In this case, these electrodes are connected to the conductor 20 and the housing 300 and are provided on different sides of the slot 25.

### Second Modified Example

In the antenna device 100B shown in FIG. 23, one end of the feed circuit 30 and one end of the coil L2 are electrically connected to the GND electrode 41. In an antenna device of a second modified example, more portions are electrically connected to the GND electrode.

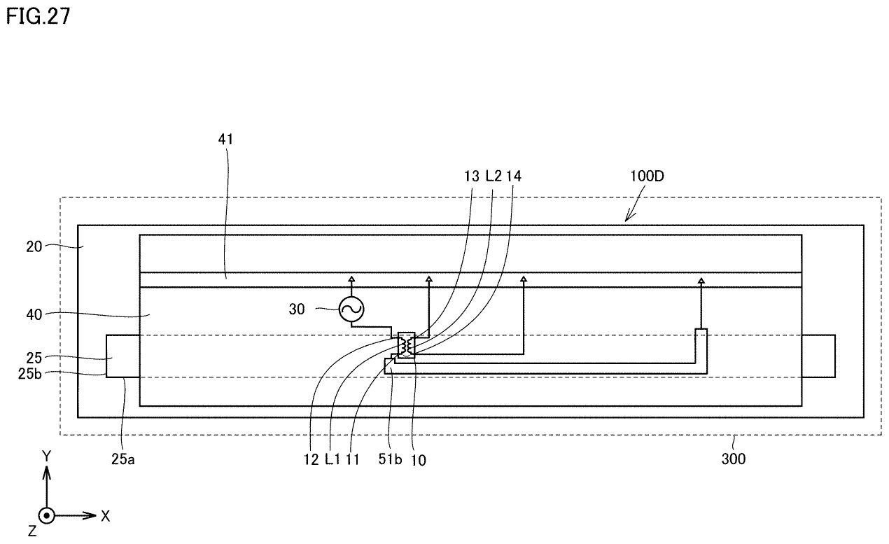

FIG. 27 is a schematic view of an electronic apparatus including an antenna device 100D of the second modified example of the second example embodiment. As illustrated in FIG. 27, the electronic apparatus includes the antenna device 100D, a feed circuit 30 that feeds power to an excitation electrode 51b (first excitation electrode), and a housing 300 that houses the antenna device 100D and the feed circuit 30. An element of the electronic apparatus including the antenna device 100D identical to the corresponding element of the electronic apparatus including the antenna device 100 in FIG. 1 and that of the electronic apparatus including the antenna device 100B in FIG. 23 is designated by like reference numeral and a detailed explanation thereof will not be repeated.

In the antenna device 100D, a slot 25 elongated in the X direction is provided in a planar conductor 20, and the excitation electrode 51b is provided at a position corresponding to the slot 25. That is, in the antenna device 100D, the excitation electrode 51b operates as a capacitor feed element with respect to the slot 25, and the excitation electrode 51b and the peripheral portion of the slot 25 are electrically (capacitively) coupled with each other so as to be excited as a slot antenna. The slot antenna including the slot 25 and the excitation electrode 51b defines and functions as a feed antenna.

Unlike the excitation electrode 51a shown in FIG. 23, the excitation electrode 51b has an elongated shape in the X direction along the slot 25, and one end of the excitation electrode 51b is electrically connected to one end (first outer electrode 11) of the coil L1, and the other end of the excitation electrode 51b is electrically connected to the GND electrode 41 of the substrate 40.

In the antenna device 100D, one end (fourth outer electrode 14) of the coil L2 is electrically connected to the GND electrode 41 of the substrate 40, and the other end (third outer electrode 13) of the coil L2 is also electrically connected to the GND electrode 41. In the antenna device 100D, as a result of connecting the coil L2 to the GND electrode 41, a current flows from the feed circuit 30 to the peripheral portion of the slot 25 via the coil L1, which is magnetically coupled with the coil L2, whereby the antenna device 100D is excited as an antenna.

As illustrated in FIG. 27, in the antenna device 100D, not only one end of the feed circuit 30 and one end of the coil L2, but also one end of the coil L1 and the other end of the coil L2 are also electrically connected to the GND electrode 41. In the antenna device 100D, therefore, more points from which a current flows to the GND electrode 41 are provided and more paths through which a current flows from the feed circuit 30 to the peripheral portion of the slot 25 via the antenna coupler 10 are provided than those of the antenna device 100B shown in FIG. 23, thereby making it possible to widen the bandwidth. The configuration discussed in the first modified example may be combined with the configuration discussed in the second modified example. In FIG. 27, the excitation electrode 51b and lines linking the excitation electrode 51b and the GND electrode 41 are separately shown. It may be possible, however, that the boundaries between the excitation electrode 51b and these lines are not necessarily clear.

### Third Modified Example

In the antenna device 100B shown in FIG. 23, by the use of the antenna coupler 10, the slot antenna excited by the excitation electrode 51a that receives power from the feed circuit 30 and the slot antenna that does not receive power, which is a parasitic antenna, are provided. In an antenna device of a third modified example, a slot antenna, which is a feed antenna, and a slot antenna, which is a parasitic antenna, are provided, without using the antenna coupler 10.

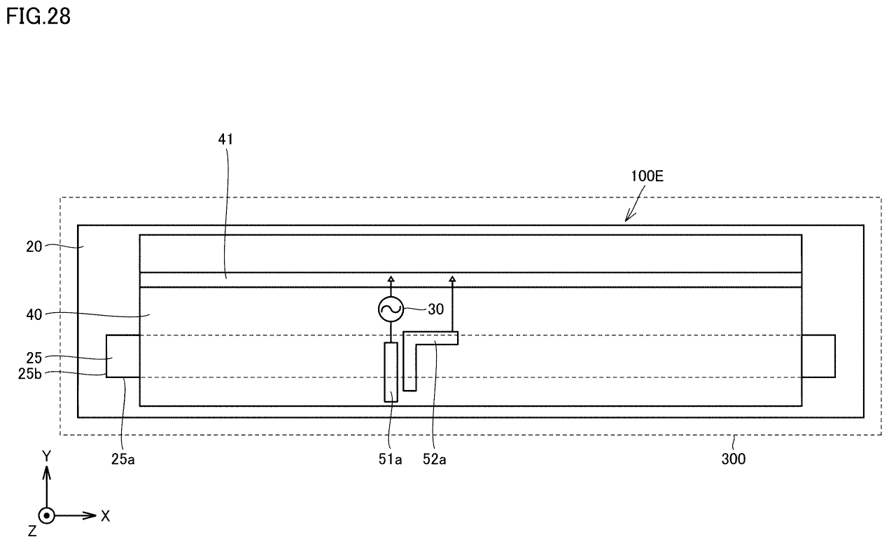

FIG. 28 is a schematic view of an electronic apparatus including an antenna device 100E of the third modified example of the second example embodiment. As illustrated in FIG. 28, the electronic apparatus includes the antenna device 100E, a feed circuit 30 that feeds power to an excitation electrode 51a (first excitation electrode), and a housing 300 that houses the antenna device 100E and the feed circuit 30. An element of the electronic apparatus including the antenna device 100E identical to the corresponding element of the electronic apparatus including the antenna device 100 in FIG. 1 and that of the electronic apparatus including the antenna device 100B in FIG. 23 is designated by like reference numeral and a detailed explanation thereof will not be repeated.

In the antenna device 100E, a slot 25 elongated in the X direction is provided in a planar conductor 20, and the excitation electrode 51a is provided near the slot 25. That is, in the antenna device 100E, the excitation electrode 51a operates as a capacitor feed element with respect to the slot 25, and the excitation electrode 51a and the peripheral portion of the slot 25 are electrically (capacitively) coupled with each other so as to be excited as a slot antenna. The slot antenna including the slot 25 and the excitation electrode 51a defines and functions as a feed antenna.

In the antenna device 100E, an excitation electrode 52a is provided near the excitation electrode 51a. One end of the excitation electrode 52a is connected to a GND electrode (substrate electrode) 41 of the substrate 40. The excitation electrode 52a has an L-like shape including a portion provided in parallel with the excitation electrode 51a (in the Y direction) and a portion provided in parallel with the GND electrode 41 (in the X direction). At the portion where the excitation electrodes 51a and 52a are provided in parallel with each other, the excitation electrodes 51a and 52a are electromagnetically coupled with each other. Hence, a current flowing from the feed circuit 30 to the excitation electrode 51a causes an excitation current to flow through the excitation electrode 52a.

In the antenna device 100E, as a result of connecting one end of the excitation electrode 52a to the GND electrode 41, a current flows from the feed circuit 30 to the peripheral portion of the slot 25 via the portion where the excitation electrodes 51a and 52a are provided in parallel with each other, whereby the antenna device 100E is excited. With this configuration, without using the antenna coupler 10, the antenna device 100E can form a slot antenna that receives power from the feed circuit 30 and a slot antenna that does not receive power, thus leading to a reduction in the manufacturing cost. The configurations discussed in the first and second modified examples may be combined with the configuration discussed in the third modified example.

The disclosed example embodiments are provided only for the purposes of illustration, but are not intended to be exhaustive or to limit the disclosure to the precise forms disclosed. It is intended that the scope of the disclosure be defined, not by the foregoing description, but by the following claims. The scope of the present disclosure is to be accorded the broadest interpretation so as to encompass all such modifications and equivalent structures and functions.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna device comprising:
a conductor with a planar shape and a slot; first and second excitation electrodes at positions corresponding to the slot;
a first coil including a first end electrically connected to the first excitation electrode and a second end connected to a feed circuit; and
a second coil including a first end electrically connected to the second excitation electrode; wherein
the first coil and the second coil are positioned to be magnetically coupled with each other.

2. The antenna device according to claim 1, wherein the first and second excitation electrodes are at positions at which the first and second excitation electrodes overlap the slot in a plan view of the slot.

3. The antenna device according to claim 2, further comprising:
a substrate between the first and second excitation electrodes and the conductor.

4. The antenna device according to claim 1, wherein
the slot has a rectangular or substantially rectangular shape including first and second sides, the second side being shorter than the first side; and
the first and second excitation electrodes have a strip shape extending along the first side.

5. The antenna device according to claim 4, wherein a first direction in which the first excitation electrode extends and a second direction in which the second excitation electrode extends are opposite directions along the first side.

6. The antenna device according to claim 1, further comprising:
a capacitor connected in series between the second coil and the second excitation electrode.

7. The antenna device according to claim 1, wherein
the first and second coils provide an antenna coupler including:
an insulator;
first, second, third, and fourth outer electrodes on surfaces of the insulator; and
the first and second coils including a plurality of conductor patterns inside the insulator;
a plurality of conductor patterns of the first coil include a conductor pattern electrically connected to the first outer electrode or the second outer electrode;
a plurality of conductor patterns of the second coil include a conductor pattern electrically connected to the third outer electrode or the fourth outer electrode; and
an opening of the first coil and an opening of the second coil overlap each other, as viewed from a stacking direction of layers of the insulator.

8. The antenna device according to claim 7, wherein
the first excitation electrode is electrically connected to the first outer electrode of the antenna coupler;
the feed circuit is electrically connected to the second outer electrode of the antenna coupler;
the second excitation electrode is electrically connected to the third outer electrode of the antenna coupler; and
the fourth outer electrode of the antenna coupler is grounded.

9. The antenna device according to claim 7, wherein the first coil includes:
a first conductor pattern electrically connected to the first outer electrode and including at least two layers connected in parallel with each other; and
a second conductor pattern stacked on the first conductor pattern and electrically connected to the second outer electrode, the second conductor pattern being connected in series with the first conductor pattern;
the second coil includes:
a third conductor pattern electrically connected to the third outer electrode and including at least two layers connected in parallel with each other; and
a fourth conductor pattern stacked on the third conductor pattern and electrically connected to the fourth outer electrode, the fourth conductor pattern being connected in series with the third conductor pattern; and
the first and second coils are inside the insulator so that the second conductor pattern and the fourth conductor pattern face each other in the stacking direction of the layers of the insulator.

10. An electronic apparatus comprising:
the antenna device according to claim 1;
the feed circuit to feed power to the first excitation electrode; and
a housing that houses the antenna device and the feed circuit.

11. The electronic apparatus according to claim 10, wherein the first and second excitation electrodes are at positions at which the first and second excitation electrodes overlap the slot in a plan view of the slot.

12. The electronic apparatus according to claim 11, further comprising:
a substrate between the first and second excitation electrodes and the conductor.

13. The electronic apparatus according to claim 10, wherein
the slot has a rectangular or substantially rectangular shape including first and second sides, the second side being shorter than the first side; and
the first and second excitation electrodes have a strip shape extending along the first side.

14. The electronic apparatus according to claim 13, wherein a first direction in which the first excitation electrode extends and a second direction in which the second excitation electrode extends are opposite directions along the first side.

15. The electronic apparatus according to claim 10, further comprising:
a capacitor connected in series between the second coil and the second excitation electrode.

16. An antenna device comprising:
a conductor with a planar shape and a slot;
an excitation electrode at a position corresponding to the slot;
a first coil including a first end electrically connected to the excitation electrode and a second end connected to a feed circuit; and
a second coil including a first end electrically connected to a substrate electrode electrically connected to the conductor; wherein
the first coil and the second coil are positioned to be magnetically coupled with each other.

17. The antenna device according to claim 16, wherein a second end of the second coil is electrically connected to the substrate electrode.

18. The antenna device according to claim 16, wherein
the substrate electrode is provided along at least two sides of the slot;
the feed circuit is electrically connected to a portion of the substrate electrode provided along a first side of the slot; and
one end of the second coil is electrically connected to a portion of the substrate electrode provided along a second side of the slot, the second side being a side different from the first side.

19. The antenna device according to claim 16, wherein
the first and second coils provide an antenna coupler including:
an insulator;
first, second, third, and fourth outer electrodes on surfaces of the insulator; and
the first and second coils including a plurality of conductor patterns inside the insulator;
a plurality of conductor patterns of the first coil include a conductor pattern electrically connected to the first outer electrode or the second outer electrode;
a plurality of conductor patterns of the second coil include a conductor pattern electrically connected to the third outer electrode or the fourth outer electrode; and
an opening of the first coil and an opening of the second coil overlap each other, as viewed from a stacking direction of layers of the insulator.

20. An electronic apparatus comprising:
the antenna device according to claim 16;
the feed circuit to feed power to the excitation electrode; and
a housing that houses the antenna device and the feed circuit.
